(19) United States
(12) Patent Application Publication
(10) Pub. No.: US 2004/0181496 A1
(43) Pub. Date: Sep. 16, 2004

(54) Networked metered parking system

(75) Inventors: Matthew Odinotski, St. Leonard (CA); Fernando Petruzziello, Montreal (CA)

Correspondence Address: DARBY & DARBY P.C., P. O. BOX 5257, NEW YORK, NY, 10150-5257, US

(73) Assignee: MECHTRONIX SYSTEMS INC., St-Laurent (CA)

(21) Appl. No.: 10/645,303

(22) Filed: Aug. 21, 2003

Related U.S. Application Data
(60) Provisional application No. 60/404,760, filed on Aug. 21, 2002.

(51) Int. Cl. G07B 15/02; G06F 17/00

(52) U.S. Cl. 705/418

(57) ABSTRACT

The networked metered parking system of the present invention uses a database distributed over a plurality of parking payment terminals (hereinafter referred to as standalones), which provides a low lag time, high redundancy, wide area network with point-to-point communication, standalones and portable terminals aid in the use, payment, maintenance, enforcement, management, and continuous auditing of the metered parking system of the present invention.

### CROSS REFERENCE TO RELATED APPLICATION

The present application claims benefit of priority under 35 U.S.C. §119(e) of provisional application Ser. No. 60/404,760, filed Aug. 21, 2002, which is hereby incorporated herein by reference in its entirety.

### FIELD OF THE INVENTION

The present invention relates to a metered parking system and more particularly to a networked metered parking system where parking payment terminals (or standalones) embody a distributed database for providing a wide area network having a low lag time and high redundancy.

### BACKGROUND

It is well known, in urban areas, to provide for parking spaces for which a user pays. A variety of different systems are known, and the most important will be reviewed herein.

Single Space Mechanical and Electronic Meters

In one of the simplest parking meter systems in use, parking is paid for at individual meters, each corresponding to an individual parking space. An enforcement officer periodically checks the meters where vehicles are parked to determine which vehicles are parking in violation. Some drawbacks to this system are that a motorist can pay for parking at only one specific terminal, time is wasted by the enforcement officer's need to inspect the meter by every parked car, and parking meter aspects and useful information can be accessed only at the meter itself, and not from a more convenient location, such as the parking manager's office. These meters are also hindered by inaccurate timers, and a susceptibility to coin fraud. A simple electronic version of these meters has been introduced to improve the timers and coin detectors. Nonetheless, in both mechanic and electronic versions, payments cannot be achieved through credit, debit or smart

Non-Networked Pay and Display

In a different parking system, a number of parking spaces can be paid for at a designated kiosk. The kiosk produces a slip which displays the time for which parking has been paid for. The motorist displays this slip on the dashboard of the vehicle. This system inconveniences the motorist in a trip back to the vehicle to display the receipt on the dash. Furthermore, time is wasted in that the enforcement officer must first locate the slip on the dashboard of the vehicle, and then carefully read the slip to determine whether the vehicle is in violation. Other disadvantages to this system are: it is more difficult for the enforcement officer to detect fraudulent receipts through the glass of the windshield; motorists who neglect to remove expired slips from the dash force the enforcement officer to first determine which is the valid slip; and in winter, enforcement officers must scrape away snow and ice from the windshields in order to view the slip. More importantly, because meters are not networked, they cannot handle credit, debit or smart card and maintenance/statistical information cannot be retrieved easily.

Non-Networked Pay and Go

To remedy drawbacks of Pay and Display, parking systems have been developed wherein fees for a number of parking spaces are paid for at a designated kiosk. The motorist inputs parking space or vehicle identification information into an information storage means at the kiosk, makes the required payment, and then leaves without needing to return to the vehicle. Enforcement officers can then verify the status of parked cars by interfacing directly with the data storage medium in the kiosk through wired or wireless communication means. A drawback to this method is that parking information is isolated on each individual kiosk, restricting the analysis and transfer of parking information to and from management. Again, because meters are not networked, they cannot handle credit, debit or smart card payments.

Batch-Based Broadcast Systems

Proposals have been made to further improve the situation by interconnecting all payment terminals into a broadcast-based wireless network. A control centre communicates on a regular basis with parking terminals through a wireless network. These improvements resolve some drawbacks of the systems mentioned above: blacklists for credit and debit card payments are therefore downloaded to each meters and maintenance alarms as well as statistical information can be retrieved. However, motorists cannot pay at any parking terminal as parking information is still processed only within one meter; there is a substantial delay between the time at which a maintenance alarm is recorded at a terminal and the time where a message is sent to the control centre; it is impossible to make real-time bank approvals on credit card or smart card payments. Another major problem is that should a Payment terminal malfunction, or become damaged or disconnected from the network, critical data can be lost, and the Payment terminal will become unable to manage its related parking spaces until repaired.

Real-Time Broadcast Systems

Proposals have been made to further improve the situation by interconnecting all payment terminals into a real-time broadcast-based wireless network. Payment terminals communicate with a wireless transmitter, which broadcasts the parking status of spaces to the portable terminals of enforcement officers. Furthermore, a central computer stores and processes all parking information. These improvements resolve some drawbacks of the systems mentioned above: wireless communication with the terminals is possible, motorists can pay for parking at almost any payment terminal, and enforcement officers need not check a dashboard or meter display for parking information as it is broadcast to all portable terminals, when used as pay and go. However, this set-up raises new problems. For example, there is a substantial delay between the time the motorist inputs data into the Payment terminal, and the time when this data arrives on the portable terminal of the enforcement officer. The information must first be transmitted from the Payment terminal to the wireless network, generally using the public network, and then, after data handling, from the wireless network to the portable terminals. As a parking space may expire, or be paid for, during this delay, the enforcement officer is sometimes supplied with erroneous information, increasing legal fees and public contempt for the managing organization. Another problem is that should a Payment terminal malfunction, or become damaged or disconnected from the network, critical data can be lost, and the Payment terminal will become unable to manage its related parking spaces until repaired. Furthermore, if the central management system is down, the complete parking network cannot operate. Since broadcast-based systems generally use the public wireless telephone network, it involves high operational costs and lower reliability.

Also known in the art are U.S. patents applications and U.S. Pat. Nos. 2001/0039509 (Dar et al.), 2001/0051531 (Singhal et al.), 2002/0077953 (Dutta), 2002/0084915 (Budnovitch), 2002/0163444 (Budnovitch), 2003/0128136 (Spier et al.), U.S. Pat. No. 4,603,390 (Mehdipour et al.), U.S. Pat. No. 5,029,094 (Wong), U.S. Pat. No. 5,065,156 (Bernier), U.S. Pat. No. 5,648,906 Amirpanahi), U.S. Pat. No. 5,737,710 (Anthonyson), U.S. Pat. No. 5,845,268 (Moore), U.S. Pat. No. 5,940,481 (Zeitman), U.S. Pat. No. 6,026,367 (Hjelmvik), U.S. Pat. No. 6,111,522 (Hiltz et al.), U.S. Pat. No. 6,147,624 (Clapper), U.S. Pat. No. 6,195,015 (Jacobs et al), U.S. Pat. No. 6,230,868 (Tuxen et al.), U.S. Pat. No. 6,246,337 (Rosenberg et al.), U.S. Pat. No. 6,246,338 (Hjelmvik), U.S. Pat. No. 6,249,233 (Rosenberg et al.), U.S. Pat. No. 6,266,609 (Fastenrath), U.S. Pat. No. 6,275,169 (Krygler et al.), U.S. Pat. No. 6,285,297 (Ball), U.S. Pat. No. 6,292,110 (Budnovitch), U.S. Pat. No. 6,340,935 (Hall), U.S. Pat. No. 6,344,806 (Katz), U.S. Pat. No. 6,411,937 (Brusseaux), U.S. Pat. No. 6,493,676 (Levy), U.S. Pat. No. 6,501,391 (Racunas, Jr.), U.S. Pat. No. 6,502,011 (Haag), U.S. Pat. No. 6,505,774 (Fulcher et al.), U.S. Pat. No. 6,519,329 (Hjelmvik), U.S. Pat. No. 6,577,248 (Hjelmvik)and Re 37822 (Anthonyson), which show other examples of metered parking system.

### SUMMARY

An object of the invention is to provide a networked metered parking system that can overcome the problems and drawbacks mentioned above.

Another object of the present invention is to provide a wireless networked metered parking system using a distributed database.

Another object of the present invention is to provide a networked metered parking system which provides a low lag time, high redundancy, wide area network with point-to-point communication.

Another object of the present invention is to provide a networked metered parking system wherein the synchronization of the network components is done through GPS based data or other similar systems.

According to the present invention, there is provided a payment parking terminal for managing use of a plurality of parking spaces comprising a user interface, fee collection means, data processing means, wireless communication means, data storing means and a clock for keeping time. The user interface comprises input 10 and output means for interacting with the payment parking terminal. The fee collection means collects and associates a payment with one of the parking spaces. The payment associated with one of the parking space is parking-related data. The data processing means processes the parking-related data. The wireless communication means sends the parking-related data to at least another one of the payment parking terminal and receives parking-related data from at least another one of the payment parking terminal. The data storing means stores the parking-related data of the payment parking terminal and the parking-related data of the at least another one of the payment parking terminal.

According to the present invention, there is also provided a wireless point-to-point communication networked metered parking system for managing use of a plurality of parking spaces. The parking system comprises a plurality of payment parking terminals responsible for a plurality of parking spaces. Each of the payment parking terminals has a user interface comprising input and output means for interacting with the payment parking terminal, fee collection means for collecting and associating a payment with one of the parking spaces, the payment associated with one of the parking space being parking-related data, data processing means for processing the parking-related data, wireless communication means for sending the parking-related data to at least one of the payment parking terminals and for receiving parking-related data from at least one of the payment parking terminals, data storing means for storing the parking-related data of the payment parking terminal and the parking-related data of the at least one of the payment parking terminals and a clock for keeping time. The payment parking terminals are linked together wirelessly and define the point-to-point communication network, the parking-related data stored on each of the payment parking terminals is transmitted to, and stored on, at least another one of the payment parking terminals via the point-to-point communication network.

According to the present invention, there is also provided a method for implementing a wireless point-to-point communication networked metered parking system for managing use of a plurality of parking spaces. The method comprises the steps of positioning a plurality of payment parking terminal in a vicinity of a plurality of the parking spaces, configuring a point-to-point communication network by linking wirelessly the payment parking terminals together, and transmitting the parking-related data stored on each of the payment parking terminals to, and stored on, at least one of the payment parking terminals via the point-to-point communication network. The payment parking terminal are responsible for a plurality of the parking spaces. Each of the payment parking terminals comprises a user interface comprising input and output means for interacting with the payment parking terminal, fee collection means for collecting and associating a payment with one of the parking spaces, the payment associated with one of the parking space being parking-related data, data processing means for processing the parking-related data, wireless communication means for sending the parking-related data to at least one of said payment parking terminals and for receiving parking-related data from at least one of said payment parking terminals, data storing means for storing the parking-related data of said payment parking terminal and the parking-related data of the at least one of said payment parking terminals, and a clock for keeping time.

### BRIEF DESCRIPTION OF THE DRAWINGS

The present invention will be better understood after having read a detailed description of preferred embodiments thereof made in reference to the following drawings, in which like numbers refer to like elements:

FIG. 1 is a schematic representation of operational components of a parking payment terminal according to the present invention;

FIG. 2 is a schematic perspective view of a parking payment terminal 28 according to the present invention;

FIG. 3 is a schematic representation of operational components of a portable terminal according to the present invention;

FIG. 4 is a schematic perspective view of a portable terminal according to the present invention;

FIGS. 5a-b is a flowchart illustrating a “Pay & Go” operating mode of a parking payment terminal according of the present invention;

FIG. 6 is a flowchart illustrating a “Pay & Display” operating mode of a parking payment terminal according of the present invention;

FIG. 7 is a schematic representation of a networked metered parking system according to the present invention, showing a communication range of a parking payment terminal;

FIG. 8 is a schematic representation of a networked metered parking system according to the present invention, showing a parking payment terminal communicating with another parking payment terminal through intermediary parking payment terminals;

FIG. 9 is a schematic representation of a networked metered parking system according to the present invention, showing a parking payment terminal communicating with a central management station through intermediary parking payment terminals;

FIG. 10 is a flow chart illustration of the transmission of information from parking payment terminals to a central management station according to the present invention; and

FIG. 11 is a flowchart illustrating the interactions between operational components through a networked metered parking system according to the present invention.

### DETAILED DESCRIPTION OF THE PREFERRED EMBODIMENTS

The networked metered parking system of the present invention uses a database distributed over a plurality of parking payment terminals (hereinafter referred to as standalones), which provides a low lag time, high redundancy, wide area network with point-to-point communication. Standalones and portable terminals aid in the use, payment, maintenance, enforcement, management, and continuous auditing of the metered parking system of the present invention.

The wide area network (WAN) links a plurality of standalones distributed throughout an area. Each standalone is located near and responsible for, a plurality of parking spaces either at the curbside or in lots. A number, or other form of identification identifies each parking space. Parking-related data is gathered from a user at the closest standalone from the parking space he/she occupies, or at another standalone convenient to the user. The parking-related data is then sent from its point of input to the standalone responsible for the parking space identified.

An important aspect of the present invention concerns the resiliency and robustness of the distributed database. The parking related information stored in one standalone is automatically mirrored onto at least one other standalone. Consequently, the database is robust since it is decentralized, and resilient since failure of one standalone will not result in failure of the network. Furthermore, since communication between standalones preferably occurs using radio waves, the system of the present invention is not dependent on the public network, thereby decreasing the costs involved.

Referring now to FIG. 1, there are shown operational components of a standalone 2 for managing use of a plurality of parking spaces.

Processing unit 4 processes all information related to a transaction between the user and the standalone 2. Transactions are not processed at a central server, but at the standalone 2 itself. Peripheral components are controlled by the processing unit 4 for executing various tasks within the standalone 2.

For interfacing with the standalone 2, a user interface is provided. The user interface consists of all devices which facilitate the input and output of information with the various types of users of the system. The users of the system can be classified as motorists, maintenance personnel, collection officers, and parking managers.

For example, to pay for a parking space, the motorist interacts with the peripherals common in parking systems such as a receipt printer 6 and a graphical user interface (GUI) 8. The GUI 8 is preferably a LCD and Touch Screen for easy use by the motorist, but could, alternatively or in conjunction, comprise a keyboard and a display screen.

The standalone 2 also comprises fee collection devices for collecting and associating a payment with one of the parking spaces. In the illustrated case, the fee collection devices comprise magstripe and smartcard readers 10 and coin acceptor and escrow 12. The fee collection devices could also advantageously comprise a bill reader. Once a fee is collected, it is associated with the information entered by the motorist on the GUI 8 for identifying the parking space for which a payment is made. Once the transaction is completed, the transaction is now referred to as parking-related data.

In order to store the parking-related data process by the standalone 2, the standalone 2 includes data storage devices, preferably in the form of writable or re-writable media, such as solid state memory 14 and non-volatile memory 16.

The standalone 2 further comprises wireless communication devices for sending the parking-related data to at least another one standalone 2 and for receiving parking-related data from at least another one standalone 2. Furthermore, the wireless communication devices enable the standalone 2 to communicate with other components on the network, such as portable terminals. The wireless communication devices preferably comprise a radio transmitter and a radio receiver 18. The radio transmitter and receiver 18 enable the standalone 2 to communicate with other standalones 2 using radio frequencies. These radio frequencies communications are most preferably encrypted to provide a basic level of security. The processor 4 handles data encryption.

For added convenience, the wireless communication devices preferably include a base station 20 to manage and validate radio frequency communication among the transmitters and receivers 18 in other standalones 2, portable terminals, or other network components. The radio transmitter and receiver 18 of each standalone 2 and portable terminal initiate communications with the base station 20. The base station 20 contains devices to manage communications among radio transmitters and receivers. Since all components on the network contain radio transmitter and receivers 18, the base stations 20 in each standalone 2 cooperate together to manage all communications on the network. Parking-related data is transferred from one standalone 2 to another one through radio communications. The base stations 20 manage these radio communications. Parking-related data can flow from any standalone 2 on the network to any other standalone 2 as base stations 20 initiate, manage, and terminate connections between standalones 2 along the way (point-to-point communication).

The base stations 20 establish these connections with help of a routing table, which can be manual (set up by network managers) or automatic (set up by the various processing units on the network itself) (intelligent routing). Parking-related data transfer on the network is preferably packet based.

A clock for keeping track of the time is also present in each standalone 2. Preferably, the standalone 2 comprises a GPS receiver 22 to keep track of time.

This has the advantage that all the standalones 2 in the network can be synchronized using the same exact time using GPS based time.

In conjunction with GPS receiver 22, each standalone 2 preferably includes means to determine its geographical position. Again, communication with the GPS may be one method to achieve this, but other methods fall within the scope of the invention.

Various sensors 24 for detecting a malfunction within the standalone 2, an open door, bills and coins removal, the tilting of the standalone 2, maintenance needed, jam, etc., are also conveniently provided for monitoring the standalone 2.

Maintenance personnel interact with devices necessary to perform their function, such as the printer 26, the GUI and access panels for providing access to the operational components of the standalone 2. Collection officers may be required to enter codes on the GUI to gain access to the coins and/or bills deposit box embedded within the standalone 2. Parking Managers would normally not communicate with the standalones 2 directly, but rather through the network, as will be described later.

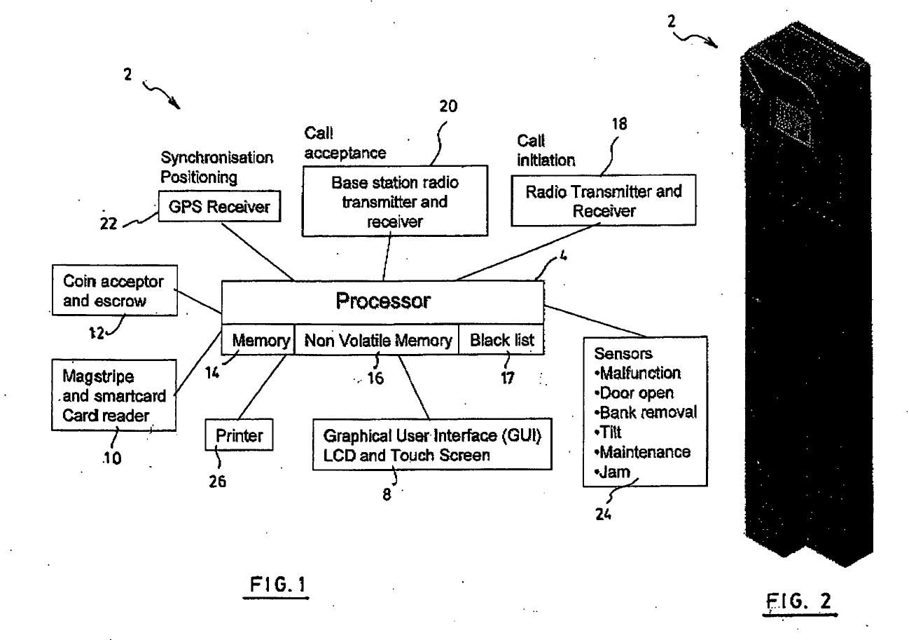

As shown in FIG. 2, it should be borne in mind that the standalones 2 are to be used outside, and therefore their construction and components must be able to withstand the rigors of the geographic location where they are placed.

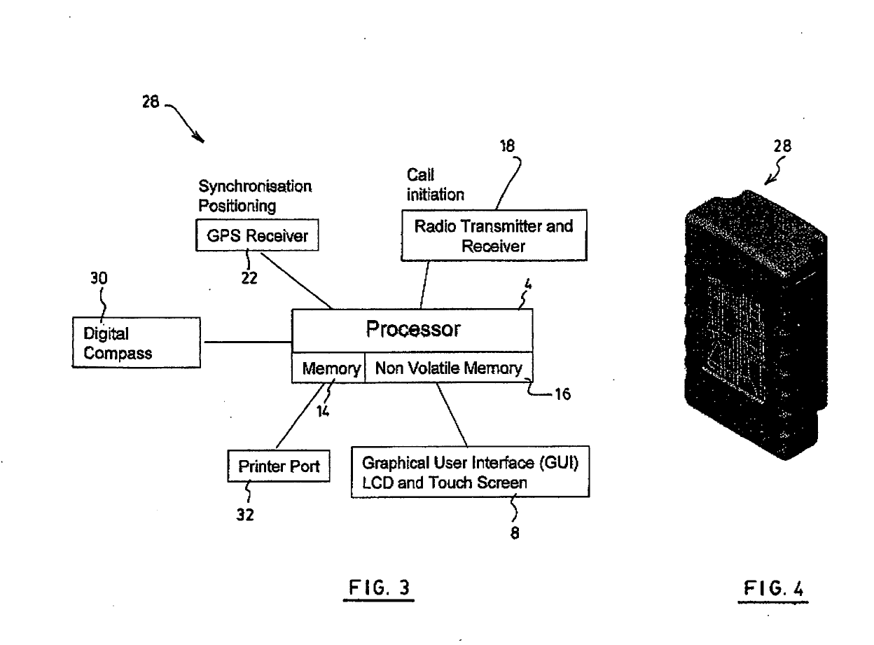

Now turning to FIG. 3, portable hand-held terminals 28 are used by parking agents (enforcement officers, maintenance personnel, money collection personnel, and parking managers) in performing their respective duties. Each portable terminal 28 comprises a user interface having input and output devices for interacting with the portable terminal 28. The portable terminal 28 also comprises wireless communication devices for requesting and receiving the parking-related data from one standalone 2, processing devices for processing the parking-related data received from the standalone 2 and position determining devices for determining the geographical position of the portable terminal 28.

The processing devices of the portable terminal 28, which comprise a processing unit 4, aids in, among other functions, displaying parking data graphically, determining the relative position of the portable terminal 28, printing receipts and infractions, guiding the user of the portable terminal 28, and exchanging data with the standalone 2.

In order to store the parking-related data received from the standalone 2, the portable terminal 28 includes data storage devices, preferably in the form of writable or re-writable media, such as solid state memory 14 and non-volatile memory 16.

The communication devices of the portable terminal 28 preferably consist of a radio transmitter and receiver 18, which may communicate with the radio transmitter and receiver 18 of any given standalone 2. This communication would be preferably managed by any of the base stations 20 (or equivalent devices) of the standalones 2 within range.

The position determining devices of the portable terminal 28 aid the portable terminal 28 in determining where it is, and thereby may graphically display its pertinent surroundings, such as the relative location of parking spaces and standalones 2 to the user. The position determining devices of the portable terminal 28 also aid the portable terminal 28 in determining which standalone 2 is closest to its position, and therefore which standalone 2 it will communicate with. This may be accomplished through a GPS receiver 22. The GPS receiver 22 also contributes to the synchronisation of the portable terminal 28 with the standalones 2 on the network.

The portable terminal 28 can also comprises direction determining devices to aid in the graphical representation of the immediate surroundings, in that as the user changes direction, the graphical display will reflect this rotation. For this purpose, a digital compass 30 might be embedded in the portable terminal 28. The direction determining devices can also advantageously use the GPS receiver 22.

The user interface of the portable terminal 28 contains all input-output devices necessary for ease of use. These include, but are not restricted to, a graphical user interface (GUI) 8, a LCD and Touch Screen, buttons or a keyboard, a card-reader for officer identification, a keyboard, a track-ball, a printer port 32, etc.

When inspecting the status of any given parking space, the enforcement officer views all relevant information on the portable enforcement terminal 28. This information is sent to the portable terminal 28 from the standalone 2 responsible for that parking space. The transfer of information is triggered by the enforcement officer, by the portable terminal 28, or by a combination of methods. In any given case, the trigger or triggers used to initiate a download will be specified in the parameters of the system, and may vary depending on the situation. In general however, the download is initiated either by the enforcement officer or by the portable terminal 28. In the first instance, the enforcement officer triggers the download of parking-related data by entering a street address, standalone 2 identification number, or parking space identification number. Pertinent information for that area will then be downloaded to the portable terminal 28. Depending on the preferred setup of the system, the portable terminal 28 itself may also request parking space data. It may trigger a request if its location (preferably determined by GPS) is within a predetermined distance of a standalone 2, or, if the signal strength from one specific standalone 2 is decidedly stronger than all others, or by a combination of methods.

Again, the portable terminal 28 allows enforcement officers to perform their duties by giving access to parking space status, and issuing parking infractions. It also allows the portable terminal 28 user to configure, collect data, and diagnose individual pay stations.

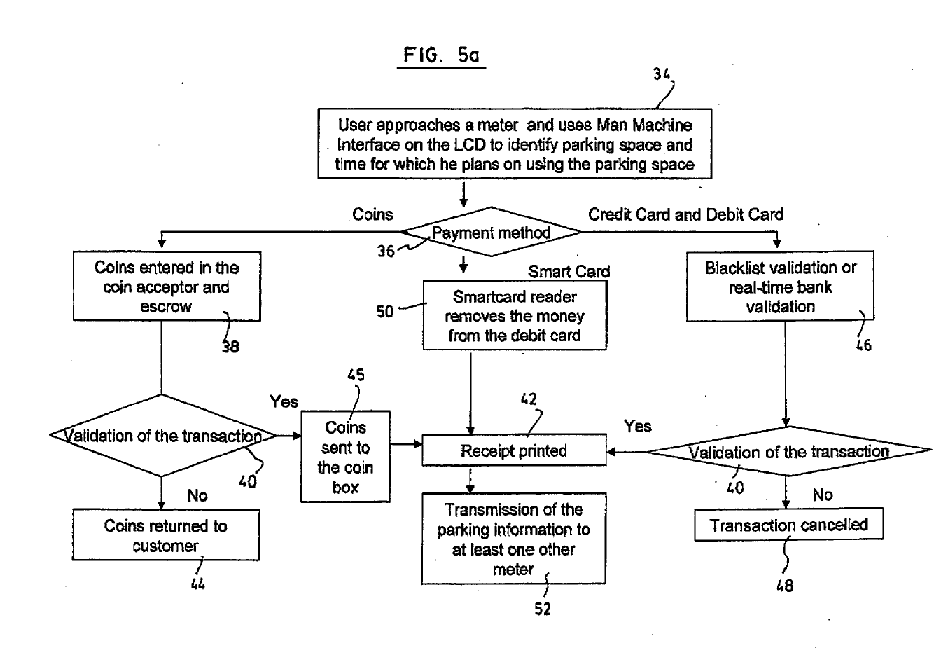

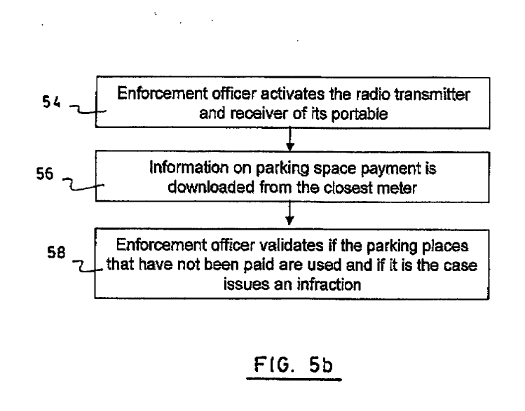

As shown in FIG. 4, the portable terminal 28 is a small self-contained computing device that can communicate via radio frequency (RF) with multiple standalones 2 or with a central station to download parking information in real-time. This parking-related data is displayed in an intuitive, user-friendly, and graphical manner that would make the enforcement officer duties as easy, or easier than the current manual patrolling procedure.

The unit should be robust enough to withstand a hostile environment, which includes being mishandled or being dropped, and withstand a wide temperature range. A simple cradle for charging and mounting the unit within a vehicle is required which allows the officer to quickly install and remove the enforcement terminal 28 without having to struggle with wires or connectors.

The standalone 2 is used in a “Pay & Go” mode. To better facilitate understanding of the “Pay & Go” mode payment process, FIGS. 5a-b show a flowchart representing the major steps executed by the standalone 2 in order to process a transaction for a parking space. The user approaches a standalone 2, uses the GUI 8 to identify the parking space and time for which he plans on using the parking space 34. Tree payment methods 36 are offered to him: coins, smartcard or credit and debit cards. If the user uses coins to pay, the coins are entered in the coin acceptor and escrow 38. Then, if the processor validates the transaction 40, the coins are sent to the coin box 45. The printer prints out a receipt 42 noting the time and date of the expiration of authorized parking, as well as the parking space identification, and possibly other information (parking information important to the motorist, i.e. “vehicle must be removed by 6:00 PM” or “parking fees to increase January 1^{st}”, etc.; advertising; etc. Otherwise, if the transaction is not validated, the coins are returned to the user 44. If the credit and debit cards payment method is chosen by the user, the card is verified through a blacklist 17 validation or real-time bank validation 46. The blacklist is preferably stored within the standalone itself. If the transaction is validated 40, again a receipt is printed out 42 noting the previously described information. If the transaction is not validated, the transaction is cancelled 48. If the smartcard payment method is chosen by the user, the smartcard reader removes a certain amount of money from the debit card 50. Independently of which payment method is used, once the receipt is printed out 42, the receipt can be kept by the user, and does not need to be placed on the dashboard of the parked vehicle. Once the receipt is printed out, the standalone 2, through its wireless communication devices, transmits the parking-related information to at least one other standalone 52. To validate that a payment is still valid for a parking space, an enforcement officer activates the radio transmitter and receiver of its portable terminal 54. Parking-related data is downloaded from the closest standalone 56. The enforcement officer validates if the parking spaces that have not been paid for are used and if it is the case, he/she issues an infraction 58.

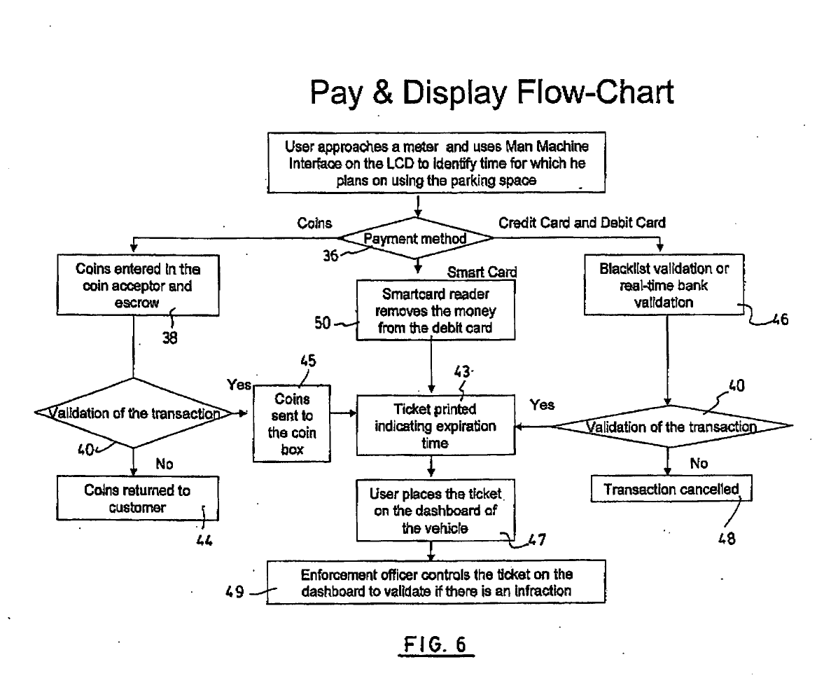

However, as shown in FIG. 6, the standalone 2 can also be used in a “Pay & Display” mode. The user approaches a standalone 2, uses the GUI 8 to identify the parking space and time for which he plans on using the parking space 34. Tree payment methods 36 are offered to him: coins, smartcard or credit and debit cards. If the user uses coins to pay, the coins are entered in the coin acceptor and escrow 38. Then, if the processor validates the transaction 40, the coins are sent to the coin box 45. The printer prints out a receipt indicating expiration time of authorized parking 43. Otherwise, if the transaction is not validated, the coins are returned to the user 44. If the credit and debit cards payment method is chosen by the user, the card is verified through a blacklist 17 validation or real-time bank validation 46. If the transaction is validated 40, again a receipt is printed out 42 noting the previously described information. If the transaction is not validated, the transaction is cancelled 48. If the smartcard payment method is chosen by the user, the smartcard reader removes a certain amount of money from the debit card 50. Independently of which payment method is used, once the receipt is printed out 43, the user places the receipt on the dashboard of the parked vehicle 47. Then, an enforcement officer controls the receipt on the dashboard to validate if there is an infraction 49. In the “Pay & Display” mode, the network functionalities of the standalone 2 are still used, for example, to send alarm messages to a central management station in real-time, to verify credit and debit cards validity in real-time with the banks databases, etc.

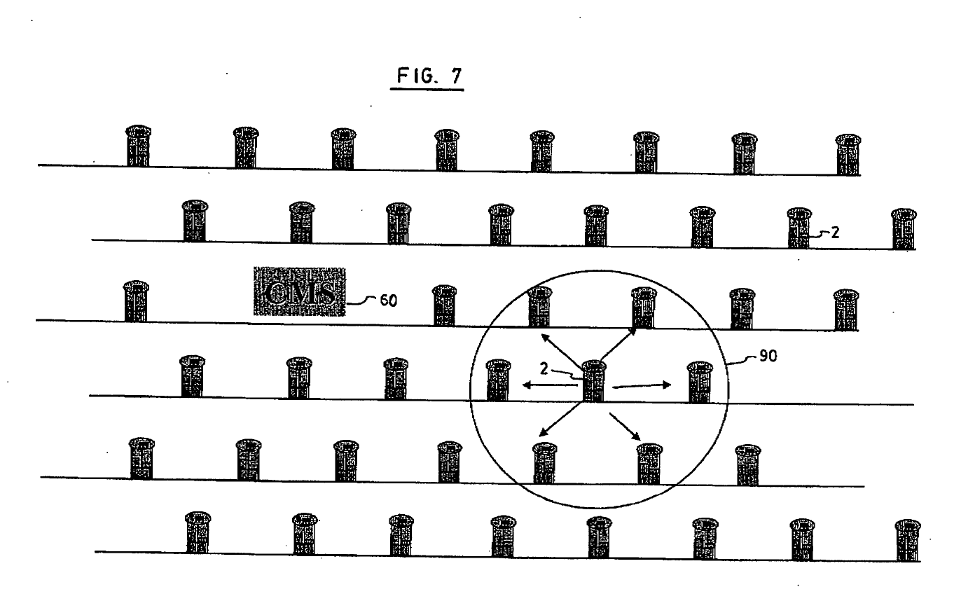

Referring now to FIGS. 7 to 9, a central management station (CMS) 60 is for use by the parking managers. Linked to the network, the central management station 60 can download data from the network's distributed database. The central management station 60 compiles the data from various standalones 2 on the network and, through appropriate software, can display the contents of the database in various forms.

As mentioned previously, an important aspect of the present invention is that it does not require the use of a dedicated network. Each standalone 2 contains a base station 20 through which each standalone 2 is able to communicate with at least one of the standalones 2 surrounding it. When a portable device comes near a group of standalones 2, the portable terminal 28 determines which standalone 2 it will communicate with. This decision is made using signal strength, information from the satellite connection, and/or other methods. The selected standalone 2 then communicates parking-related data directly with the portable terminal 28, virtually eliminating lag time.

Information from the standalone 2 is transferred directly to a specific portable terminal 28. This transfer is initiated by a trigger, such as a request from the enforcement officer, proximity of the portable device to the standalone 2, etc. The transfer of information is not “pushed” through the system by the input of information from the motorist, but “pulled” by the request of the employment officer.

As better shown in FIG. 7, each standalone 2 monitors permanently radio frequency communication with neighbor standalones 2 to identify the best route for signal transmission based on signal strength and GPS positioning information. Best routes are then fed to the standalones' 2 internal routing table.

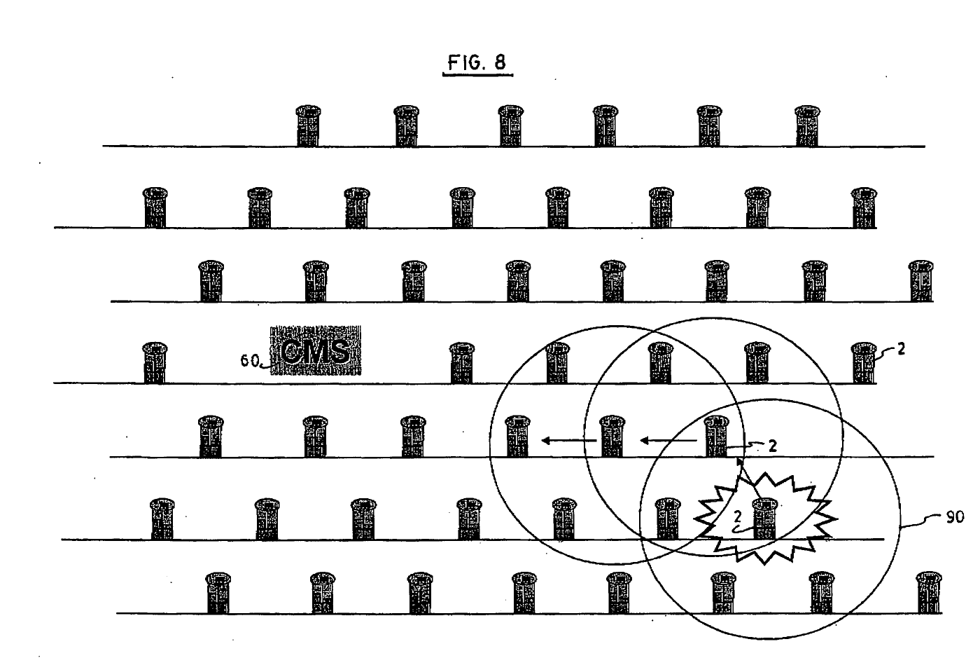

As better shown in FIG. 8, parking-related data is mirrored on at least one other standalone 2.

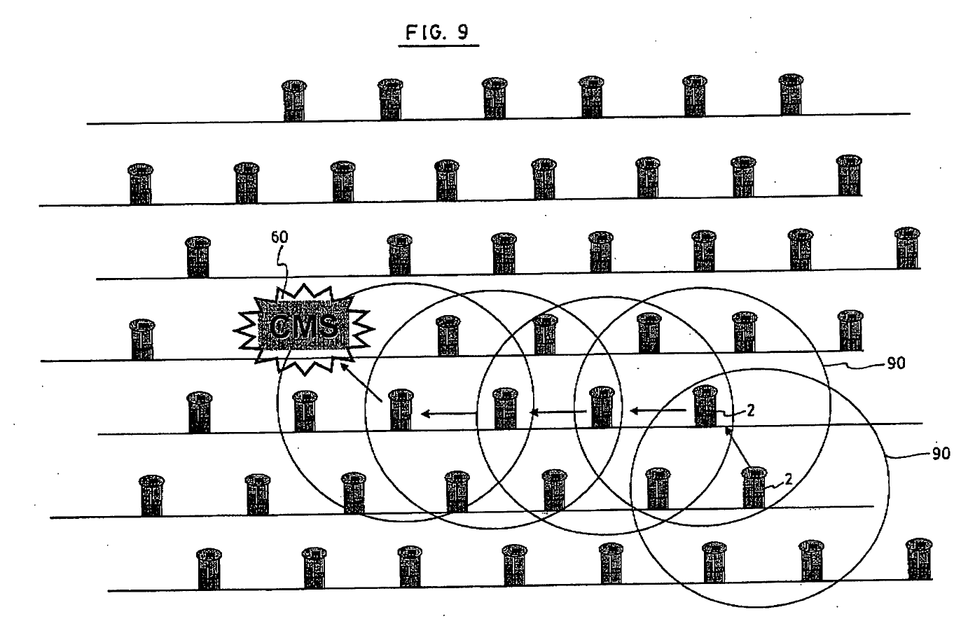

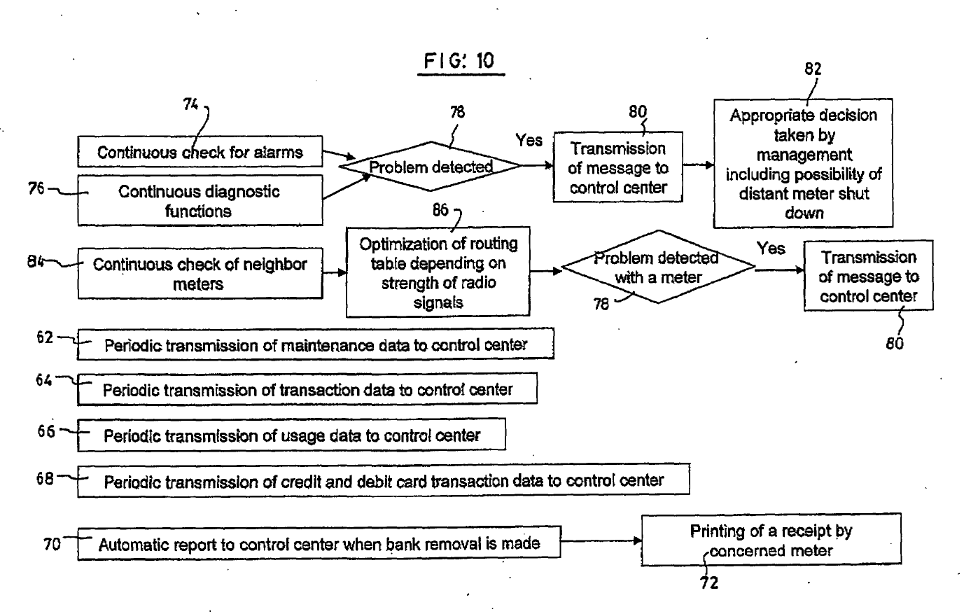

As better shown in FIG. 9, a standalone 2 communicates with the CMS 60. Alarms are automatically sent to the CMS 60. Usage, maintenance, credit and debit card transaction data are periodically sent to the CMS.

Parking-related data may travel from any standalone 2 to any other standalone 2 by being transmitted successively from one standalone 2 to another. For example, if standalone A wishes to exchange data with standalone D, it may do so by sending its data first to standalone B, which will send the data to standalone C, which will send the data finally to standalone D (this feature is termed intelligent routing). If one or more standalones 2 becomes unable to communicate, the intelligent routing strategy will reroute the data around the non-communicative standalone(s) 2 through other standalones 2.

The function of all units on the network can be controlled with the central management station 60. The central management station 60 can directly or indirectly communicate with any standalone 2 on the network. For example, if the CMS 60 wishes to exchange data with one standalone, it may do so by sending its data first to another standalone, which will send the data to another standalone, which will send the data finally to the desired standalone (intelligent routing). However, if the desired standalone is in the communication range of the CMS 60, the CMS 60 will directly communicate with the desired standalone.

Parameter modifications of the various components on the network can be input at the central management station 60, and then downloaded to the standalones 2 themselves by means of the network. For example, if the parking managers wish to modify the tariff per hour of selected parking spaces, the modification would be made at the central management station 60 and the information would be downloaded to the relevant standalones 2. The flow of this information across the network, as always, would be transferred from standalone 2 to standalone 2 until the final destination is reached. In this example of a tariff change, the modification can be made for selected, or all parking spaces, for a limited period, or indefinitely. If the modification is for all parking spaces, then the information of this modification would jump from standalone 2 to standalone 2 across the network, until all standalones 2 have been reached. Of course, it would also be possible to make parameter modifications directly on the standalone 2 itself through its GUI 8.

Referring to FIG. 10 the central management station 60 (also referred to as a control center) periodically receives various information from the standalones 2 on the network. In the illustrated case, the standalones 2 periodically send maintenance data 62, parking-related data 64, usage data 66 and credit and debit card transaction data 68 (parking-related data) to the control center 60. An automatic report can also be send to the control center when bills or coins are removed 70 from the standalones 2. The concerned standalone 2 then preferably prints a receipt 72 to be kept by the collecting officer.

Preferably, the standalones 2 continuously check for alarms 74 triggered by their sensors 24 and execute self-diagnostics functions 76. If a problem is detected 78, a message is transmitted 80 from the standalone 2 to the control center 60. Then, appropriate decision is taken 82 by management personnel, including the possibility to shut down the standalone 2. Advantageously, the standalones 2 can also continuously check for the presence of neighbor standalones 84. If the strength of the radio signal coming from a particular standalone 2 is low or cannot be detected, the standalone 2 can optimize its routing table 86. If after a predetermined amount of time the standalone still cannot communicate t the network, a problem is thus detected 78 by the standalone regarding the standalone with a low signal strength or no signal at all, a message is transmitted 80 from the standalone 2 to the control center 60. Again, appropriate decision are taken by management personnel.

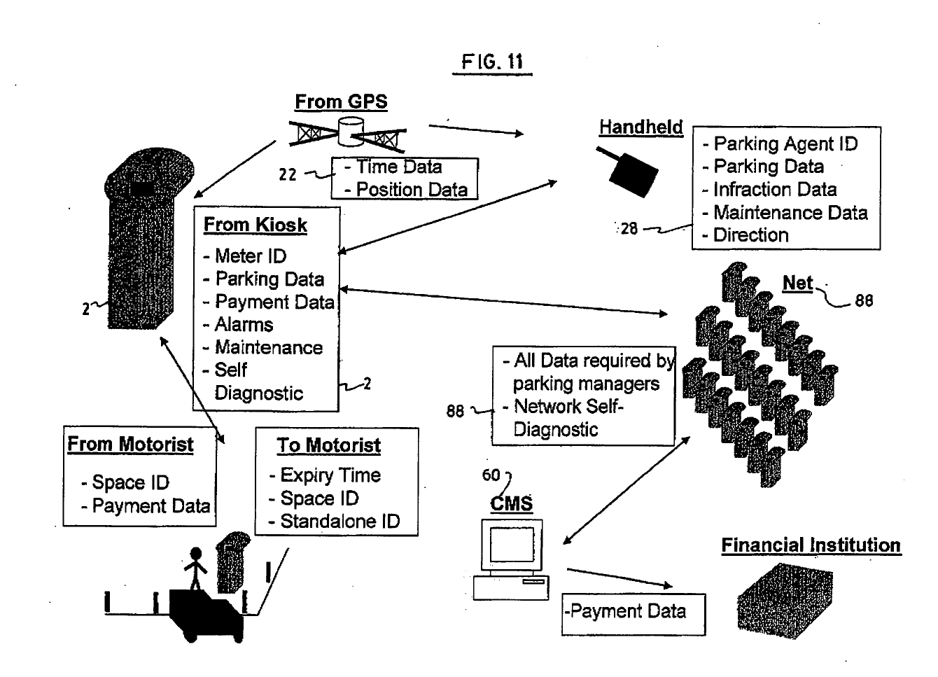

Referring now to FIG. 11, there is shown a summary of information flow within the networked metered parking system. Since there is no need for a dedicated network, there is similarly no central database. All data of the system is contained on the standalones 2, distributed on the network 88. The distributed database is created through the simultaneous transfer of parking-related data (mirroring). No one standalone 2 on the network contains all the data. Data is distributed by means of overlapping subsets within a group of standalones 2 on the system. One standalone 2 can manage data on other standalones 2 as well as on its own.

All the data necessary for the completion of any transactions at a standalone 2 is contained on the standalone 2 itself.

Information moves across the network by jumping from one standalone 2 to another. Consequently, each standalone 2 is able to communicate directly with any other standalone 2 on the network. Each standalone 2 contains a base station 20 and radio transmitter and receiver 18, wherein the radio transmitter and receiver 18 of any standalone 2 can initiate communication with any other standalone 2 within range by way of its base station 20. That is, when one standalone 2 is to communicate with another, the radio transmitter and receiver 18 of the first standalone 2 initiates communication with the base station of the other standalone 2.

Standalones 2 out of range can communicate with each other through intermediary standalones 2. For example, standalone A, can send information to a standalone 2 out of radio range, say standalone Z, whereby standalone A first sends the information to a standalone 2 within range of itself, yet closer on the network to standalone Z, standalone B. Standalone B then transfers the information to another standalone 2, still closer on the network to standalone Z, standalone C. This process continues until the information reaches the target standalone 2. Any number of standalones 2 can exist between standalone A and standalone Z. In this way, information may travel from any point on the network to any other point. Network managers, or the network 88 itself, will decide on the best way to do this. Such strategies are known in the art. One possible method could be a simple table, wherein possible paths from point X to point Y on the network are delineated. Or, each packet of information can have a network address attached to it. The packet will then be routed by each standalone 2 to the next standalone 2 along the best possible path. Data transfer throughout the network can be intelligently routed by any of these communication strategies, as well as a number of others.

Information flow between any two standalones 2 is managed by the network, is adaptable, and is able to circumvent bottlenecks or downed areas. That is to say that data on the network can be routed around radio obstructions, malfunctioning standalones 2, or any other type of gap in the network.

No transaction at a standalone 2 is complete until it has been mirrored on at least one other standalone 2. As it will be appreciated, the number of standalones 2 to be mirrored on any given transaction is controllable.

Transactions, as they occur on an initial standalone 2, are stored on any of a first set standalones 2 within radio range of the initial standalone 2. This information can then be further transferred on any of a second set of standalones 2, all of which are within range of at least one standalone 2 of the first set of standalones 2. This information can be further sent to any number of sets of standalones 2 as long as all the standalones 2 in one set are within communication range of at least one standalone 2 in the previous set. The number of sets upon which transaction information is communicated is termed the “radius of redundancy” 90 (better shown on FIGS. 6 to 8) of the first standalone 2. This radius of redundancy 90 is either determined by the system, or defined by network managers. In effect, the radius of redundancy 90 of the network determines the number of standalones 2 that will be mirrored on any given transaction. Each standalone 2 is able to communicate directly with any of a number of other standalones 2 in its vicinity, or indirectly to a remote standalone 2 though intelligent routing. Each standalone 2 will mirror its transactions on a number of other standalones 2, wherein this number is determined by the radius of redundancy 90. This provides for a high degree of redundancy. The radius of redundancy 90 effectively increases the level of data redundancy throughout entire system.

As mentioned previously, each standalone 2 contains means to determine the exact time. The preferred method of accomplishing this would be for each standalone 2 to contain means to communicate with the GPS.

The satellite connection capabilities of standalones 2 and portable terminal 28 provide a reliable and accurate means for each unit to determine its location as well as its relative position to other units. This aids the portable terminal 28 in selecting which standalone 2 to communicate with at any given time. This also aids standalones 2 in establishing a routing table.

Since the database is distributed over the network, and processing takes place on either the standalones 2 or the portable terminals 28, this parking system has no need for a central server, other than a central location for some purposes.

Each standalone 2 autonomously manages a set of parking spaces. Pertinent information (status of parking space, time of status change, rates, schedule of metered parking, etc) concerning each parking space is stored in the standalone 2.

The standalones 2 (or payment parking terminals 28) allow a motorist to register parking intent and pay parking fees for a given period. The standalones 2 transmit through the network all relevant data to a central management station. However, no data need be transmitted to the central management station 60 for the proper functioning of the parking system of the present invention, or any of the individual components. It is at the discretion of the parking managers what information they require and when they require it. For the most part, information flow to the central management station 60 can be divided into two categories: urgent information, and historical information. Urgent information, such as warnings from specific standalones 2 (ambient temperature dangerously low, out of paper, tampering/vandalism taking place, etc.) is normally transmitted immediately, either to the central management station, and then to the portable terminal 28 of the parking agent concerned, or, directly to the respective parking agent through the network. This type of information requires very low bandwidth. Historical information (how many vehicles parked at given spaces, bank/credit card transactions, status report from all standalones 2, etc.) requires a much larger amount of data, but need not be downloaded immediately. Historical downloads can take place during periods of decreased network activity, such as late at night.

When other network components are within range, communication is done directly by radio frequency communication. When out of communication range, intelligent routing is used to enables network components to communicate together.

The parking system of the present invention has the following advantages and features:

All relevant information accessed at the standalone 2 is immediately available. All transactions with a standalone 2 are processed on the standalone 2 itself. Since the standalone 2 does not need to immediately communicate with a central server in order to complete a transaction, the user experiences no lag-time. However, a transaction is not considered to be complete unless the transaction has been mirrored on at least one other standalone 2.

Since there is no main transmitter, and each portable terminal 28 communicates only with the standalone 2 in its immediate range, the portable terminal 28 experiences no lag-time.

There is no network downtime, due to the radius of redundancy 90 and mirroring of parking-related data, the ability of any standalone 2 to manage the database and operations of any other standalone 2, intelligent routing on the network and the absence of any central computer. Thus, the network experiences zero downtime. Failure of any particular standalone 2, or number of standalones 2, within the network, does not halt the network or the continuous function of the system.

Since all transactions at a standalone 2 are mirrored on other standalones 2, the chance of data loss on the distributed database is insignificant.

The number of standalones 2 on which parking-related data is mirrored will increase the lag-time of that transaction. Standalones 2 are able to take over the parking management of malfunctioning standalones 2 in their vicinity. Therefore, parking spaces associated with an “out of order” standalone 2 can still generate revenue.

Due to the lack of any central computer or central information conduit, any number of standalones 2 or portable terminals 28 can be added to the network without the need for overhauls, upgrades or major changes to the system. There is a possible bottleneck during downloads to the central management station 60, but these downloads are performed during low network usage hours, when parking is no longer metered.

A satellite connection and time determination capabilities of standalones 2 aid in their quick implementation. As new units are added to the network, the system autonomously ascertains their location and existence on the network.

Preferably during low traffic periods on the network, any information contained on the standalones 2 or portable devices can be uploaded to the central management station 60 for analysis, processing, or storage. Information is sent to its final destination by jumping (in a consistent direction) from standalone 2 to standalone 2, until arriving at the central management station 60. In this way, the entire distributed database (or any portion thereof) can be downloaded to the central management station 60. To be sure, the central management station is not a server, and is not critical to the functioning of the network. It is simply a station, or series of stations, that enable parking managers to view parking data, and manage the system.

The fact that this network exists on the public domain, as well as the absence of a central server, a central database, or central software, significantly reduces the total cost of this network. Some existing networks rely on a server to store data, handle information processing, etc. They can be said to be the central brains of a network. This network has no requirement for a central server. All data necessary for the functioning of the network is spread out among the standalones 2. All data processing is done at the standalones 2 themselves. In this network, the “central management station/system” is essentially a another standalone unit 28 waiting for information from the standalones 2, so the managers can be informed as to what is going on. Another of its uses is to modify the parameters of the network/standalones/portable terminals, without requiring a technician to walk to each component to make the changes in person. In fact, entire swaths of the network itself (standalones 2 essentially) could sink into the river, and the remaining standalones 2 would continue to work just fine.

Preferably, motorists pay for parking at the nearest standalone 2, at any other standalone 2, by phone, by cell phone, on the Internet, or through a variety of other methods. Regardless of the payment method, the payment information is transferred to the standalone 2 responsible for the parking space paid for. Some examples of possible payment strategies are listed here. At a standalone 2, motorists can pay by: coin, bill, credit card, bank card and pre-paid parking card.

The motorist inputs either the desired parking duration, in which case the standalone 2 displays the amount of money required, or the motorist simply pays a given amount. The standalone 2 then issues a printed receipt, which displays information pertinent to the driver, such as parking expiry time, parking space ID number, and location of parking space.

Phone transactions, if applicable, are charged to the account of the owner of the phone service, and a portion or all of these funds are relayed to the parking service providers. Similarly, internet payments may follow any of a number of standard strategies.

The motorist can extend parking duration at any time with any of the payment methods by simply allocating more funds to the parking ID of their space. If the parking time, and grace period, has expired, the motorist will be required to go through the payment process from the beginning, as if parking in that space for the first time that day.

Hereinabove, a function description from the point of view of the users is described.

The motorist selects the desired parking space and notes its unique identification. The motorist then pays for the parking at the closest standalone 2, at another standalone 2 convenient to the motorist, by phone or cell phone, or by the internet. Whatever the means, the user associates the transfer of funds with the parking space ID. The standalone 2 then prints a receipt of this transaction, if the transaction has been done on the standalone, possibly with other information useful to the motorist (time of default, parking space ID etc.) and the motorist continues on his way without needing to return to the vehicle. At any time prior to the expiry of the allotted time, parking time can be extended by the transfer of more funds to the system, and relation of those funds to the specific parking space by means of the parking space ID. The funds can be transferred by inserting money at the original standalone 2, at any other standalone 2, or by any of the other methods mentioned above. If the allotted time of a particular space has elapsed, more time can be allotted by forwarding funds to the system along with the parking space ID. However, this action would be equivalent to that of a new motorist initiating new parking time for that space.

As an enforcement officer approaches a grouping of parking spaces managed by a standalone 2, a request is made for status information of the parking spaces. This request is initiated by the officer through the portable terminal 28, or by the proximity of the portable terminal 28 to the standalone 2. Pertinent parking information (space paid for/not paid for, etc.) is then downloaded from the standalone 2 to the enforcement officer's portable terminal 28. This information can be displayed by text, by means of a map of the proximate area or by other methods. The map graphically displays which spaces are presently paid for and which are not. The enforcement officer then has the option to input the vehicle's license plate number and print a receipt using the portable terminal 28. The portable terminal 28 includes other pertinent information on the receipt, such as time of day, enforcement officer ID, location, infraction type, etc.

While embodiments of this invention have been illustrated in the accompanying drawings and described above, it will be evident to those skilled in the art that changes and modifications may be made therein without departing from the essence of this invention.

1. A payment parking terminal 28 for managing use of a plurality of parking spaces comprising:
a user interface comprising input and output means for interacting with the payment parking terminal 28;
fee collection means for collecting and associating a payment with one of the parking spaces, the payment associated with one of the parking space being parking-related data;
data processing means for processing the parking-related data;
wireless communication means for sending the parking-related data to at least another one of said payment parking terminal 28 and for receiving parking-related data from at least another one of said payment parking terminal 28;
data storing means for storing the parking-related data of said payment parking terminal 28 and the parking-related data of the at least another one of said payment parking terminal 28; and
a clock for keeping time.

2. The payment parking terminal 28 according to claim 1, wherein the wireless communication means comprises a radio transmitter and a radio receiver.

3. The payment parking terminal 28 according to claim 2, wherein the wireless communication means further comprises a base station for initiating, managing, terminating and validating radio frequency communications among the radio transmitters and radio receivers of the payment parking terminal 28 and at least another one of the payment parking terminals 28.

4. The payment parking terminal 28 according to claim 3, wherein the base station initiates the radio frequency communications with another one of the payment parking terminals 28 via a routing table.

5. The payment parking terminal 28 according to claim 1, wherein the parking-related data stored on the storage means is mirrored onto at least another one of the payment parking terminals 28.

6. The payment parking terminal 28 according to claim 1, wherein the wireless communication means transmits the parking-related data to a portable terminal 28 comprising:
a user interface comprising input and output means for interacting with the portable terminal 28;
wireless communication means for requesting and receiving the parking-related data from the payment parking terminal 28;
processing means for processing the parking-related data received from the payment parking terminal 28;
data storing means for storing the parking-related data received from the payment parking terminal 28; and
position determining means for determining a geographical position of said portable terminal 28.

7. The payment parking terminal 28 according to claim 6, wherein the wireless communication means of the portable terminal 28 comprises a radio transmitter and a radio receiver for radio frequency communications with the payment parking terminal 28.

8. The payment parking terminal 28 according to claim 6, wherein the portable terminal 28 further comprises direction representing means for representing a graphical display of immediate surroundings via the output means.

9. The payment parking terminal 28 according to claim 3, wherein the base station initiates the radio frequency communications directly with another one of the payment parking terminals 28 located within a predetermined communication range.

10. The payment parking terminal 28 according to claim 9, wherein the base station initiates the radio frequency communications indirectly with another one of the payment parking terminals 28 located outside the predetermined communication range via at least another one of the payment parking terminals 28 located within the predetermined communication range.

11. The payment parking terminal 28 according to claim 1, further comprising position determining means for determining a geographical position of the payment parking terminal 28.

12. The payment parking terminal 28 according to claim 11, wherein the position determining means is GPS based.

13. The payment parking terminal 28 according to claim 1, wherein the clock is GPS based.

14. The payment parking terminal 28 according to claim 1, wherein the output means issues a receipt noting time and a date expiration of authorized parking associated with the payment.

15. The payment parking terminal 28 according to claim 1, wherein the parking-related data is packet based.

16. The payment parking terminal 28 according to claim 1, wherein the wireless communications means sends the parking-related data to a central management station, the central management station comprising compiling and displaying means for compiling and displaying the parking-related data.

17. The payment parking terminal 28 according to claim 16, further comprising self-diagnostic means for performing self-diagnostic functions on the payment parking terminal 28 and producing self-diagnostic data, the self-diagnostic data being send to the central management station for analysis.

18. The payment parking terminal 28 according to claim 3, the radio frequency communications are encrypted and decrypted by the processing means for providing security.

19. A wireless point-to-point communication networked metered parking system for managing use of a plurality of parking spaces, the parking system comprising a plurality of payment parking terminals 28 responsible for a plurality of parking spaces, each of the payment parking terminals 28 having:
a user interface comprising input and output means for interacting with the payment parking terminal 28;
fee collection means for collecting and associating a payment with one of the parking spaces, the payment associated with one of the parking space being parking-related data;
data processing means for processing the parking-related data;
wireless communication means for sending the parking-related data to at least one of said payment parking terminals 28 and for receiving parking-related data from at least one of said payment parking terminals 28;
data storing means for storing the parking-related data of said payment parking terminal 28 and the parking-related data of the at least one of said payment parking terminals 28; and
a clock for keeping time,
the payment parking terminals 28 being linked together wirelessly and defining the point-to-point communication network, the parking-related data stored on each of the payment parking terminals 28 being transmitted to, and stored on, at least another one of the payment parking terminals 28 via the point-to-point communication network.

20. The parking system according to claim 19, wherein the wireless communication means comprises a radio transmitter and a radio receiver.

21. The parking system according to claim 20, wherein the wireless communication means further comprises a base station for initiating, managing, terminating and validating radio frequency communications among the radio transmitters and radio receivers of the payment parking terminal 28 and at least another one of the payment parking terminals 28.

22. The parking system according to claim 21, wherein the base station initiates the radio frequency communications with another one of the payment parking terminals 28 via a routing table.

23. The parking system according to claim 19, wherein the wireless communication means transmits the parking-related data to a portable terminal 28 comprising:
a user interface comprising input and output means for interacting with the portable terminal 28;
wireless communication means for requesting and receiving the parking-related data from one of the payment parking terminals 28;
processing means for processing the parking-related data received from one of the payment parking terminals 28;
data storing means for storing the parking-related data received from the payment parking terminal 28; and
position determining means for determining a geographical position of said portable terminal 28.

24. The parking system according to claim 23, wherein the wireless communication means of the portable terminal 28 comprises a radio transmitter and a radio receiver for radio frequency communications with the payment parking terminal 28.

25. The parking system according to claim 24, wherein the portable terminal 28 further comprises direction representing means for representing a graphical display of immediate surroundings via the output means.

26. The parking system according to claim 21, wherein the base station initiates the radio frequency communications directly with another one of the payment parking terminals 28 located within a predetermined communication range.

27. The parking system according to claim 26, wherein the base station initiates the radio frequency communications indirectly with another one of the payment parking terminals 28 located outside the predetermined communication range via at least another one of the payment parking terminals 28 located within the predetermined communication range.

28. The parking system according to claim 19, further comprising position determining means for determining a geographical position of the payment parking terminal 28.

29. The parking system according to claim 28, wherein the position determining means is GPS based.

30. The parking system according to claim 19, wherein the clock is GPS based.

31. The parking system according to claim 19, wherein the output means issues a receipt noting time and a date expiration of authorized parking associated with the payment.

32. The parking system according to claim 19, wherein the parking-related data is packet based.

33. The parking system according to claim 19, wherein the wireless communications means sends the parking-related data to a central management station, the central management station comprising compiling and displaying means for compiling and displaying the parking-related data.

34. The parking system according to claim 33, further comprising self-diagnostic means for performing self-diagnostic functions on the payment parking terminal 28 and producing self-diagnostic data, the self-diagnostic data being send to the central management station for analysis.

35. The parking system according to claim 21, the radio frequency communications are encrypted and decrypted by the processing means for providing security.

36. The parking system according to claim 21, the base stations of the payment parking terminals 28 cooperate together for managing all radio frequency communications on the network.

37. A method for implementing a wireless point-to-point communication networked metered parking system for managing use of a plurality of parking spaces, the method comprising the steps of:
a. positioning a plurality of payment parking terminal 28 in a vicinity of a plurality of said parking spaces, the payment parking terminal 28 being responsible for a plurality of said parking spaces, each of the payment parking terminals 28 comprising:
a user interface comprising input and output means for interacting with the payment parking terminal 28;
fee collection means for collecting and associating a payment with one of the parking spaces, the payment associated with one of the parking space being parking-related data;
data processing means for processing the parking- related data;
wireless communication means for sending the parking-related data to at least one of said payment parking terminals 28 and for receiving parking-related data from at least one of said payment parking terminals 28;
data storing means for storing the parking-related data of said payment parking terminal 28 and the parking-related data of the at least one of said payment parking terminals 28; and
a clock for keeping time;
b. configuring a point-to-point communication network by linking wirelessly the payment parking terminals 28 together; and
c. transmitting the parking-related data stored on each of the payment parking terminals 28 to, and stored on, at least one of the payment parking terminals 28 via the point-to-point communication network.

38. The method according to claim 37, further comprising the step of requesting parking-related data stored on one of the payment parking terminals 28 from a portable terminal 28, the portable terminal 28 comprising:
a user interface comprising input and output means for interacting with the portable terminal 28;
wireless communication means for requesting and receiving the parking-related data from the payment parking terminal 28;
processing means for processing the parking-related data received from the payment parking terminal 28;
data storing means for storing the parking-related data received from the payment parking terminal 28; and
position determining means for determining a geographical position of said portable terminal 28.

39. The method according to claim 37, further comprising the step of issuing a receipt noting time and a date expiration of authorized parking associated with the payment via the output means of the payment parking terminal 28.

40. The method according to claim 37, further comprising the step of transmitting the parking-related data to a central management station, the central management station comprising compiling and displaying means for compiling and displaying the parking-related data.
